(19) United States
(12) Patent Application Publication
(10) Pub. No.: US 2018/0012490 A1
(43) Pub. Date: Jan. 11, 2018

(54) Method And Apparatus For Road Surface Grip Level Differentiation

(71) Applicant: GM GLOBAL TECHNOLOGY OPERATIONS LLC, Detroit, MI (US)

(72) Inventors: Mario Jodorkovsky, Herzliya Pituach (IL); Sharon Hornstein, Herzliya Pituach (IL); Klaus Trangbaek, Herzliya Pituach (IL)

(21) Appl. No.: 15/204,472

(22) Filed: Jul. 7, 2016

(51) Int. Cl. G08G 1/0967; B60W 40/064; G01C 21/36; B60W 30/18

(52) U.S. Cl. CPC G08G 1/096708; G08G 1/096775; G08G 1/096733; B60W 30/18172; B60W 40/064; G01C 21/3697

(57) ABSTRACT

A system and method for estimating road grip conditions. More particular, the invention relates to a system and method for computationally estimating a road condition of a road location using tire-road grip data received from at least one or a plurality of vehicles and transmitting this road condition via a network such that users may anticipate upcoming road conditions.

### FIELD OF THE INVENTION

The present invention generally relates to a system and method for estimating tire-road grip conditions. More particular, the invention relates to a system and method for computationally estimating a road condition of a road location using grip data received from a plurality of vehicles and sharing this road condition via a network such that users may anticipate upcoming road conditions.

### BACKGROUND INFORMATION

Road conditions greatly affect the performance and handling of a vehicle. In autonomous and semi-autonomous vehicles, the control system must account for the available tire-road grip while controlling the vehicle and safely maximizing vehicle performance. For example, on a dry road, a vehicle may safely travel faster and perform sharper maneuvers than on a wet or icy road. It would be desirable for a vehicle control system to be able to determine grip conditions and to anticipate upcoming road conditions in order to proactively control the vehicle accordingly.

### SUMMARY OF THE INVENTION

In accordance with an aspect of the present invention, a vehicle control system comprising a receiver for receiving a first data from a first vehicle indicating a first grip level value and a first location, the receiver further operative to receive a second data from a second vehicle indication a second grip value and the first location, a processor for determining an available grip level in response to weighted first grip value and second grip value, and a transmitter for transmitting the available grip and the first location to a third vehicle.

In accordance with another aspect of the present invention a method comprising receiving a first data from a first vehicle indicating a first grip level value and a first location, receiving a second data from a second vehicle indication a second grip value and the first location, determining a road condition in response to the first grip value and the second grip value, and transmitting the road condition and the first location to a third vehicle.

In accordance with another aspect of the present invention a method comprising determining a grip level value of a road surface, determining a first location of the road surface, transmitting a first data indicating the grip level value and the first location, and receiving a second data indicating a grip level at a second location.

In accordance with another aspect of the present invention an apparatus comprising a first sensor for measuring a wheel condition, a processor for determining a grip level value of a road surface in response to the wheel condition, a second sensor for measuring a first location related to the measurement of the wheel condition, a processor for determining a first location of the road surface, a transmitter for transmitting a first data indicating the grip level value and the first location, and a receiver for receiving a second data indicating a road condition at a second location.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing a system for road surface grip level differentiation according to an exemplary environment the present invention;

FIG. 2 is a diagram showing a schematic representation of an active vehicle dynamics control system according to an exemplary environment the present invention;

FIG. 3. is a flow diagram of a method for road surface grip level differentiation according to a first exemplary environment the present invention;

FIG. 4. is a flow diagram of a method for road surface grip level differentiation according to a second exemplary environment the present invention;

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

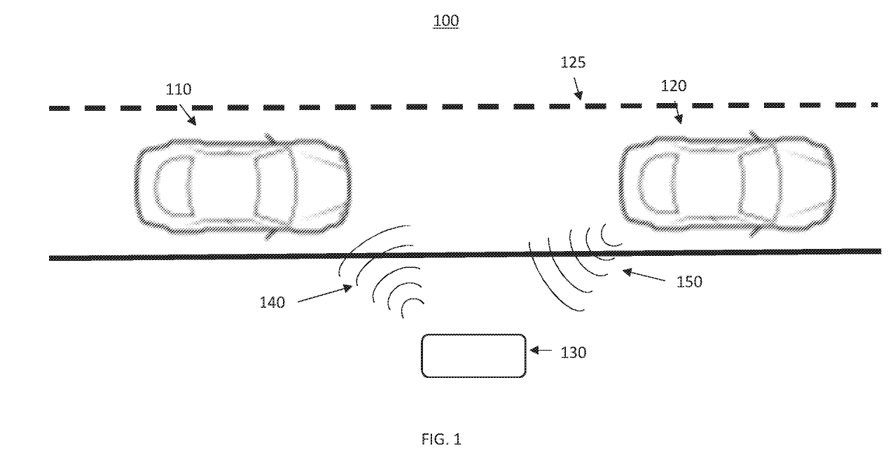

Referring now to the drawings, and more particularly to FIG. 1, an operating environment 100 illustrative of an exemplary embodiment of the present disclosure is shown. In this exemplary embodiment, the environment has a first vehicle 110 and a second vehicle 120 traveling along a road surface 125. The second vehicle 120 is equipped with sensors, such as wheel speed sensors, for determining wheel speed and/or wheel slip conditions. Information from the wheel speed sensors and from a variety of other sensors in the vehicle may be used to determine a grip value or a grip coefficient which is indicative of road conditions at the location of the second vehicle 120. Road condition may refer to, and be effected by, coefficient of friction, grip level, road surface type, tire type, tire condition, vehicle dynamics, vehicle load level, weather conditions, temperature, among others. Data indicative of the grip value and/or location of the second vehicle is transmitted to a central server 130. Alternatively, data indicative of the sensor information is transmitted directly to the central server. In addition, data indicative of the grip value may be data retrieved directly from the sensors, such as wheel speed. The central server is operative to receive the data indicative of the grip value and determine a road condition at the location of the second vehicle 120. The data indicating the road condition and the location where the data was obtained is then transmitted to other vehicles, including the first vehicle 110. A controller within the first vehicle 110 is operative to determine if the location where the data was obtained is located on a route of the first vehicle 110. —If the location is located on the route of the first vehicle 110, the controller may alter the control parameters of the first vehicle 110 in order to compensate for the upcoming road condition.

Additional information can be used in determining road conditions. Weather data may be measured or received from a third party and used to predict road conditions at the present time or at a future time. For example, if the last data indicative of grip data was received at 5 pm when the temperature was five degrees Celsius at the first location, and the temperature is now negative ten degrees Celsius, the system may predict that the road conditions may now have less grip than previously estimated.

The first vehicle 110 may further be operative to normalize the data indicative of grip value before transmitting to the central server 130. Sensor data may not be directly indicative of the grip value due to differences in vehicle configuration, such as vehicle weight, drive train, loading, payload, maintenance and/or tire pressure. The first vehicle 110 may be equipped with a processor operative to retrieve further sensor data indicating the differences in vehicle configuration and to calculate a normalized data indicative of grip value in response to the vehicle configuration. Thus, when the data is received at the central server 130, it may be applied consistently to other vehicles without alternation. Additionally, the second vehicle 120 may be further configured with a processor determines a grip value in response to the normalized data received from a central server 130 and data received from onboard sensors indicating vehicle configuration. This actual grip value can be used to determine a safe vehicle dynamics and/or operation for upcoming road conditions. For example, if the vehicle is overloaded, the vehicle may proceed slower around a curve than if the vehicle was lightly loaded. In addition, the grip value may be indicative of a maximum safe level of operation, an adjustable safe margin level may be applied to ensure that the vehicle retains grip with the road. This friction circle may be used to ensure that longitudinal and lateral forces do not overcome the frictional force of the road surface/vehicle interface. This has the desirable effect of not allowing drivers to reach unstable dynamical situations and/or assuming that in automated driving, safety is the most important feature and that these vehicles are not aimed at driving at extreme dynamical conditions.

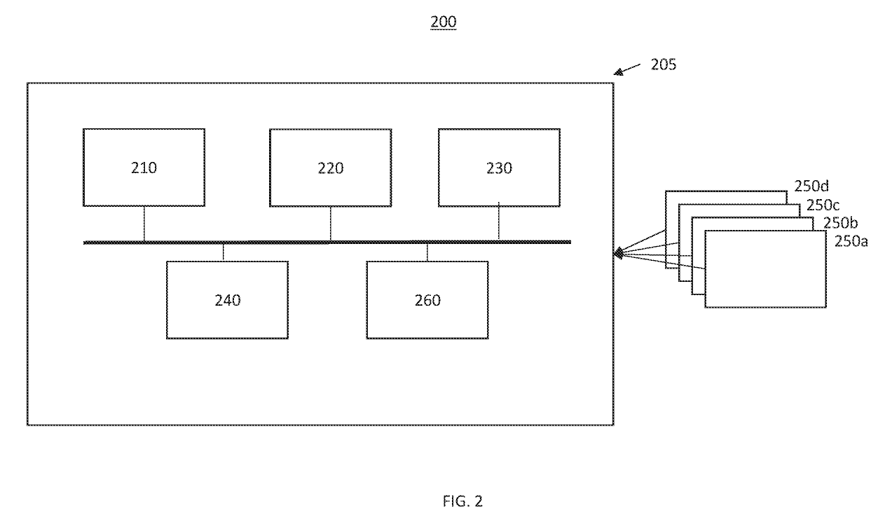

Turning now to FIG. 2, a schematic representation 200 of an exemplary embodiment of an active vehicle dynamics control system 205 onboard a vehicle. Generally, a vehicle dynamics control system 205 in a vehicle may be in communication with a global positioning system and/or a plurality of sensors or systems 210 in order to communicate signals to a controller 240. Vehicle dynamics control system 205 may include a controller 240 used for receiving information or signals from a number of sensors or systems which may include antilock brake system (ABS) status, a traction control system (TCS) status, positional and sensor data including GPS velocity, yaw rate, wheel speed (at each wheel), lateral acceleration, a steering angle (hand wheel position), longitudinal acceleration from a longitudinal accelerometer, pitch rate, and steering angle position. Steering angle position of the steered road wheels. Lateral acceleration, longitudinal acceleration, yaw rate, roll orientation and speed may also be obtained using a global positioning system (GPS). Based upon these signals, controller 240 controls the vehicle dynamics system and may store the signals in an appropriate memory 260. Depending on the desired sensitivity, the type of control system and various other factors, not all of the enumerated signals may be used in a commercial application.

The vehicle includes four wheels 250a-d, each having a respective tire mounted thereto. Although the vehicle may be a rear-wheel drive vehicle, a front-wheel drive vehicle, an all-wheel drive vehicle, or a vehicle having a selective drive configuration, the following description refers to a rear-wheel drive vehicle. Active traction control system 230, which may also referred to as an active corner exiting control system, is an onboard vehicle-based system in that its components are located on, carried by, or integrated into the host vehicle. The active traction control system 230 may include or cooperate with at least the following components or elements, without limitation: a vehicle sensor subsystem 210; a user interface subsystem 220, and an appropriate amount of memory 260. These and other elements of the active vehicle dynamics control system 205 are coupled together in an appropriate manner to accommodate the communication of data, control commands, and signals as needed to support the operation of the system. For the sake of brevity, conventional techniques related to vehicle control systems, vehicle sensor systems, torque management, and other functional aspects of the systems (and the individual operating components of the systems) may not be described in detail herein.

Sensor subsystem 210 is suitably configured to collect real-time (and possibly non-real-time) vehicle status data during operation of vehicle. The active vehicle dynamics control system 205 can process some or all of this vehicle status data in the manner described below, and other subsystems or components might also process or utilize some or all of this vehicle status data. In certain embodiments, sensor subsystem 210 includes sensors (not shown) that collect data indicative of the yaw rate of the vehicle, the lateral acceleration of the vehicle, the velocity of the vehicle, the rotational velocity of the wheels of the vehicle, the wheel slip associated with the wheels of the vehicle, the vertical and longitudinal acceleration, the vehicle pitch, the vehicle roll rate, the wheel position relative to the body of the vehicle, or the like. The design, configuration, and operational details of such vehicle-based sensors will not be described herein because these sensors and their applications are well known to those familiar with the automotive industry.

User interface subsystem 220 is suitably configured as a human-machine interface for vehicle 205 and, in particular, for system 200. User interface subsystem 220 can be realized using one or more elements, features, devices, or components, which may be conventional in nature. For example, user interface subsystem 220 may include, without limitation, any number of: buttons; knobs; switches; levers; dials; keypads; touch screens; touch pads; or the like. To support the active vehicle dynamics control system 205, user interface subsystem 220 may include one or more features or elements configured to receive a user-selected driving condition setting that is indicative of current road conditions, the current road coefficient of friction, a current tire-to-road traction value, or the like. In certain embodiments, user interface subsystem 220 also includes one or more features or elements configured to receive a user-selected vehicle handling setting, which might be indicative of a desired suspension feel, a desired handling limit, or the like.

Particular excitations are produced to allow the sensors to develop relevant information for the assessment of grip levels. A first exemplary embodiment may involve a human driven car where the driver continuously applies brakes and/or accelerations to adjust his distance to other vehicles. This activity results in excitations from the sensors which may be used to calculate grip level. A second exemplary embodiment may be in an autonomous vehicle which can be programmed to gently brake/accelerate to produce excitation without disturbing the passengers. In this case, the gentle braking/acceleration will excite the sensors to aid in determining a grip level value.

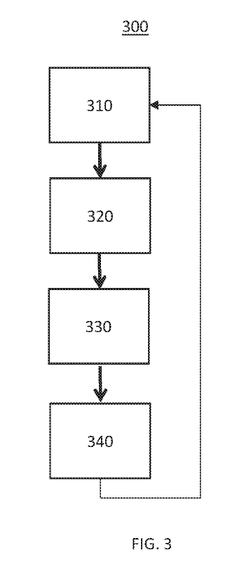

Turning now to FIG. 3, a flow diagram of a method for road surface grip level differentiation 300 according to a first exemplary environment the present invention is shown. At step 310, the exemplary method is operative to receive a first data from a first vehicle indicating a first grip level and a first location. The first grip level may be a computed grip level, normalized grip level, grip data received with vehicle configuration data, or sensor data from the first vehicle. The grip level is indicative of the road conditions experienced by the first vehicle at the first location. The first location may be indicated by GPS data or the like. At step 320, the method is operative to receive a second data from a second vehicle indicating a second grip value at the first location.

At step 330, the method determines a road condition at the first location in response to the first data and the second data. This may be done computationally in order to determine a safe road condition. The road condition may indicate a safety level or it may be a value indicating a normalized grip level.

At step 340, the road condition and data indicative of the first location is transmitted to a third vehicle. This data may be used by the third vehicle or the driver of the third vehicle to anticipate upcoming road conditions and to adjust vehicle dynamics or kinematics accordingly. If the vehicle is an autonomous vehicle the vehicle controller may adjust the vehicle dynamics or kinematics automatically. The vehicle may display a warning to a driver indicating low grip situation ahead and/or suggest a maximum speed approaching the first location and/or limiting maneuver severity.

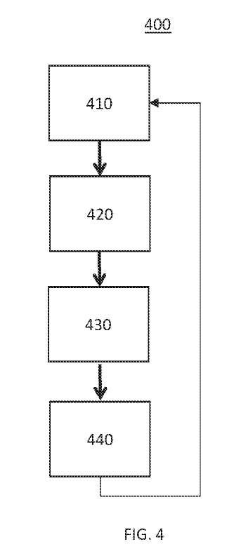

FIG. 4, a flow diagram of a method for road surface grip level differentiation 400 according to a second exemplary environment the present invention is shown. At step 410, the method is operative to determine a grip level value of a road surface. The method may be performed by a vehicle equipped with sensors, such as wheel speed sensors and/or GPS. The grip value may be normalized by taking into account the vehicle characteristics.

At step 420 the method is operative to determine a first location where the grip level value was determined. This location may be determined using a GPS or any other known method. At step 430, the method is operative to transmit data indicating the grip level value and the first location. This data may be transmitted to a central server or another vehicle.

At step 440 the method is operative to receive a second data indicating a road condition at a second location. The second data indicating a road condition may be grip level data or normalized grip level data from a second vehicle or it may be received from a central server. The method may be further operative to generate a control signal in response to the second data. The control signal may be used by an autonomous vehicle control to adjust the vehicle dynamics or kinematics, or it may be used to generate a warning to a human driver about upcoming road conditions. The second data may be received in response to a request from the first vehicle, in response to a navigation system indicating that a proposed route may include the first location, or automatically by a central server to a plurality of vehicles.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links.

What is claimed is:

1. A method comprising:
receiving a first data from a first vehicle indicating a first tire-road grip level value and a first location;
receiving a second data from a second vehicle indication a second grip value and the first location;
determining a road condition in response to the first grip value and the second grip value; and
transmitting the road condition and the first location to a third vehicle.

2. The method of claim 1 further comprises receiving a third data indicating a vehicle configuration from the third vehicle and wherein the transmitting of the road condition includes control data wherein the control data is determined in response to the vehicle configuration and the road condition.

3. The method of claim 1 wherein the road condition is also determined in response to weather data indicating weather conditions at the first location.

4. The method of claim 1 further comprising transmitting a control signal to the third vehicle in response to the road condition.

5. The method of claim 1 wherein the transmitting is performed in response to a request from the third vehicle.

6. The method of claim 1 wherein the transmitting is performed in response to a navigation route of the third vehicle.

7. A method comprising:
determining a tire-road grip level value of a road surface;
determining a first location of the road surface;
transmitting a first data indicating the grip level value and the first location; and
receiving a second data indicating a road condition at a second location.

8. The method of claim 7 further comprising:
generating a control signal to couple to a traction control system in response to the road condition.

9. The method of claim 8 further comprising determining a vehicle load characteristic and wherein the control signal is generated in response to the road condition and the vehicle load characteristic.

10. The method of claim 7 further comprising:
modifying a vehicle control dynamic in response to the road condition.

11. The method of claim 7 wherein the grip level value is determined in response to a signal from a wheel speed sensor.

12. An apparatus comprising:
a receiver for receiving a first data from a first vehicle indicating a first grip level value and a first location, the receiver further operative to receive a second data from a second vehicle indicating a second grip value and the first location;
a processor for determining a road condition in response to the first grip value and the second grip value; and
a transmitter for transmitting the road condition and the first location to a third vehicle.

13. The apparatus of claim 12 wherein the receiver is further operative to receive a third data indicating a vehicle configuration from the third vehicle and wherein the road condition includes control data wherein the control data is determined in response to the vehicle configuration and the road condition.

14. The apparatus of claim 12 wherein the road condition is also determined in response to weather data indicating weather conditions at the first location.

15. The apparatus of claim 12 further comprising transmitting a control signal to the third vehicle in response to the road condition.

16. The apparatus of claim 12 wherein the transmitting is performed in response to a request from the third vehicle.

17. The apparatus of claim 12 wherein the transmitting is performed in response to a navigation route of the third vehicle.

18. An apparatus comprising:
a first sensor for measuring a wheel condition;
a processor for determining a grip level value of a road surface in response to the wheel condition;
a second sensor for measuring a first location related to the measurement of the wheel condition;
a processor for determining a first location of the road surface;
a transmitter for transmitting a first data indicating the grip level value and the first location; and
a receiver for receiving a second data indicating a road condition at a second location.

19. The apparatus of claim 18 wherein the processor is further operative to generate a control signal to couple to a traction control system in response to the road condition; and
a traction control system for altering the control response of a vehicle in response to the control signal.

20. The apparatus of claim 19 wherein the processor is further operative determine a vehicle load characteristic and wherein the control signal is generated in response to the road condition and the vehicle load characteristic.
